(19) United States
(12) Patent Application Publication
(10) Pub. No.: US 2014/0076975 A1
(43) Pub. Date: Mar. 20, 2014

(54) Magnetic Strips, 2-D Bar Codes And QR Codes For Products

(71) Applicant: WARD KRAFT, INC., Fort Scott, KS (US)

(72) Inventors: Johnny Bellmyer, Fort Scott, KS (US); Dewayne Worthington, Mulberry, KS (US)

(73) Assignee: WARD KRAFT, INC., Fort Scott, KS (US)

(21) Appl. No.: 13/681,173

(22) Filed: Nov. 19, 2012

Related U.S. Application Data
(60) Provisional application No. 61/561,719, filed on Nov. 18, 2011.

(51) Int. Cl. G06K 19/06; G06K 7/10; G06K 7/08

(52) U.S. Cl. CPC G06K 19/06037; G06K 19/06187; G06K 7/08; G06K 7/10821
USPC 235/449; 235/493; 235/494; 235/462.1

(57) ABSTRACT

A substrate containing a magnetic strip, a 2-D bar code, or a QR bar code secured to the substrate, the magnetic strip, 2-D bar code, or QR bar code containing electronically readable information about an amount of money. The magnetic strip, 2-D bar code, or QR bar code is passed through a reader and an amount of money is credited in a sale transaction. The 2-D bar code, QR bar code, or magnetic strip may be removably secured to the substrate so that it may be removed and saved for later use.

### FIELD OF INVENTION

The field of the invention is the use of transactional magnetic strips, 2-D bar codes, and QR bar codes on paper products or other printable material, such as greeting cards, special occasion cards, business cards, florist cards, and the like.

### BACKGROUND

Magnetic strips are commonly used on credit cards and gift cards to store information about the holders account and identity. 2-D bar codes and QR bar codes (sometimes known as matrix bar codes, QR codes, or quick response codes) have the capability to encode similar information. When the strip or bar code is read by an appropriate scanner or reader and combined with other transaction data, such as the price of a purchase of goods, the information may be used to electronically communicate information to a remote location to debit and credit accounts and update bank balances, credit limits, and other transactional information.

The ease with which such strips and bar codes may now be manufactured makes it desirable to use magnetic strips, 2-D bar codes, and QR bar codes in connection with paper products such as greeting cards, birthday cards, graduation cards, special occasion cards, bookmarks, florist cards, sales receipts, care manuals, instructions, and other materials and products that may be the subject of, or involved in, a sales transaction or gift.

### SUMMARY OF INVENTION

Magnetic strips, 2-D bar codes, and QR codes, may be incorporated in greeting cards, special occasion cards, calling cards, name cards, florists cards, cards used for the purpose of including a monetary value with the card, sales receipts, instructions, and care manuals that are included with the sale or gift of goods, as well as other printed materials that are intended to be given to persons who purchase products or receive gifts, greeting cards, flowers. The 2-D bar codes, QR bar codes, and magnetic strips add a significant amount of information and/or a monetary value to the cards in which they are incorporated, and may also include advertisements. 2-D bar codes, magnetic strips, and QR codes are also small and unobtrusive and may be incorporated into the card in a way that makes them virtually undetectable, allowing them to be mailed or shipped without bulges, loose checks, plastic cards, cash or other devices or objects that signal their presence and encourage theft of the gift from the envelope.

The magnetic strips, 2-D bar codes, or QR bar codes may be permanently or removably incorporated (such as a snap out card) in the printable transactional products and used at a later time to secure a gift of cash, or other goods secured from a retail store or on the internet.

The invention allows a user to send a gift of value built into a card instead of inserting cash or gift cards into an occasion card. The portion of the greeting, birthday card, etc., that contains the value can be removed or detached and used at a later date if desired.

### BRIEF DESCRIPTION OF THE DRAWINGS

FIG. 1 is a schematic drawing showing a substrate, 2-D bar code, magnetic strip, and perforations included in the invention.

FIG. 2 is a schematic drawing of a greeting card showing a removable perforated section containing a magnetic strip.

FIG. 3 is a schematic drawing of an alternative greeting card showing a removable tab containing a magnetic strip.

### DETAILED DESCRIPTION OF INVENTION

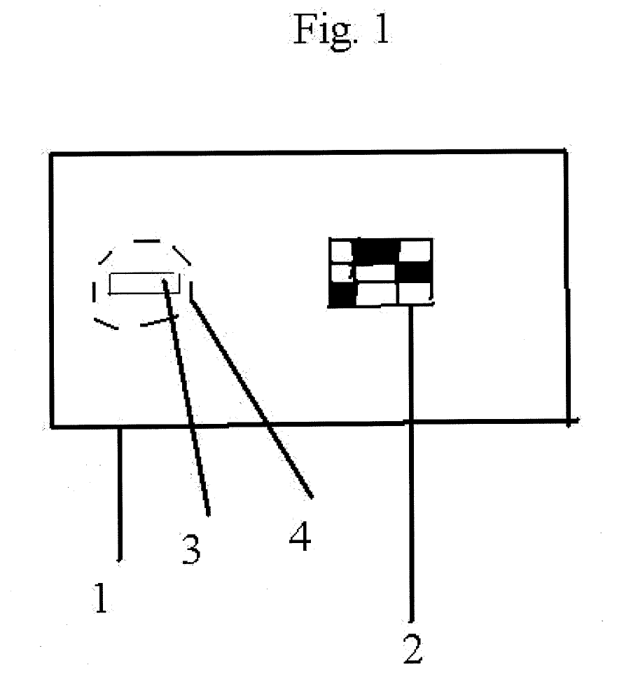

As shown in FIG. 1, a magnetic strip 3 or 2-D bar code 2 is adhesively secured to, or printed upon, a substrate 1, such as a paper card. Perforations 4 may also be placed around the magnetic strip 3 or 2-D bar code 2 so that it may be removed from the substrate 1 and used at a later time.

The substrate 1 may, if desired, be made of paper, laminated material, plastic, or other synthetic material that may be printed upon or otherwise receive the magnetic strip 3 or 2-D bar code 2.

The magnetic strip 3 or bar code 2 is coded with information pertinent to the user who receives the goods and cards, and may include a cash gift or a credit gift for use by the recipient.

It is understood that, although FIG. 1 is referenced as having the magnetic strip 3 or the 2-D bar code 2, the code may be a QR code, and there may be other or future coding systems that might be used in place of the magnetic strip, 2-D bar code 2, or QR bar code. For example in certain specialized applications, a smart chip or RFID tag could be used, or an enhanced bar code system that is capable of storing information more efficiently than a 2-D bar code or QR bar code 2. Indeed, wireless transmitters might be used instead of the magnetic strip or bar code.

The recipient may remove the magnetic strip 3 or 2-D bar code 2 from the substrate 1 and use it in a future transaction for the receipt of cash or credit or for the purchase of goods. Alternatively, the recipient may simply leave the magnetic strip 3 or 2-D bar code 2 on the substrate 1 and use it for future transactions.

The magnetic strip 3 or 2-D bar code 2 is scanned or read by a magnetic strip reader to secure the cash or credit.

In use, the magnetic strip 3 or 2-D bar code 2 may, for example, be placed on a name card that is delivered by a florist to a recipient, along with flowers. The name card may be coded for a gift of credit or cash. The recipient may save the name card and use the magnetic strip 3 or 2-D bar code 2 to receive the cash gift at the time of purchase of other goods or use the magnetic strip 3 to give money to a charity or other cause.

The magnetic strip 3 or 2-D bar code 2 may also be placed on greeting cards such as birthday cards, anniversary cards, or other special day or event cards. The card may be saved and the credit, cash, or other value contained on the card may be used in a future transaction.

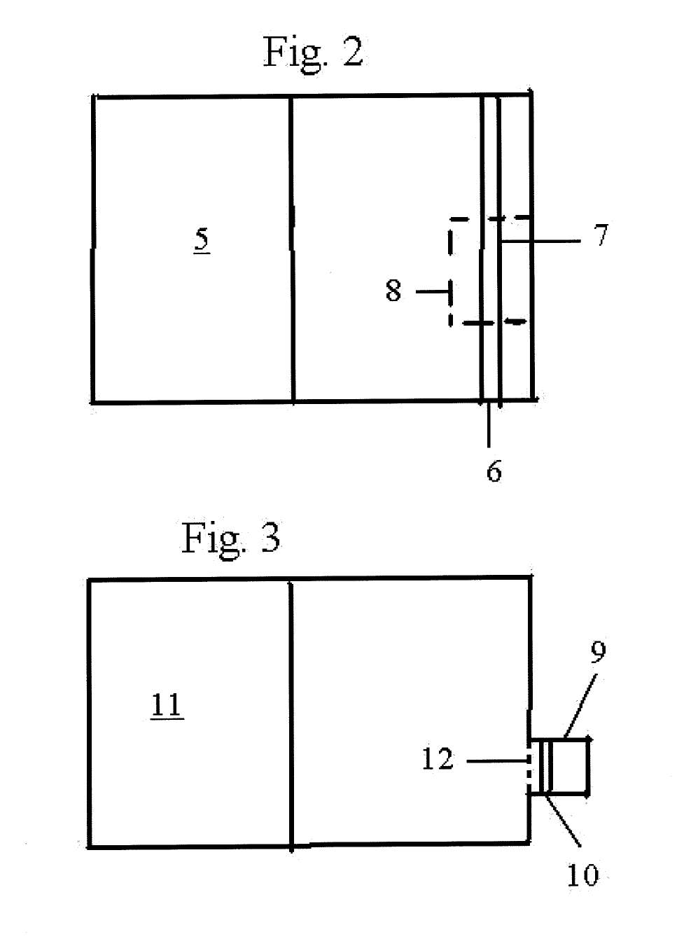

Of course the magnetic strip 3, 2-D bar code 2 (or QR code) may also be placed on a perforated portion 8 of the card and removed for safekeeping prior to use. For example, as shown in FIG. 2, a greeting card 5 has a magnetic strip 6 incorporated in the card 5. A usable portion 7 of the magnetic strip 6 may be removed from the card 5 at the perforations 8 and saved for future use. Alternatively, as shown in FIG. 3, a tab 9 containing a magnetic strip 10 may be separated from a greeting card 11 along the perforations 12.

As a further alternative, the magnetic strip 3 or 2-D bar code 2 may be removably secured to the greeting card via an adhesive and removed for safekeeping until future use. Although greeting cards are used in this example, it can be readily seen that the card or an insert may be used with any product whatsoever and incorporated in the product and other materials given to a user at the time of purchase.

The magnetic strip 3 or 2-D bar code 2 may also be placed directly on the greeting card 5, as shown in FIG. 2, and used directly via the card 5 in a future transaction.

Special cards may also be used for gifts, purchases while traveling, or other purposes. Such cards may also be provided as part of advertising, allowing the recipient to remove the magnetic strip 3 or 2-D bar code 2 and use it in connection with the purchase of the product advertised. Such use has an advantage over the use of coupons, because it may be personalized to a subscriber and used by the advertiser to track purchases by specific recipients of the advertising.

It is claimed as follows:

1. A coded device for use as a cash or credit gift comprising:
(a) a substrate made from a material that may be printed upon comprising at least one of paper, plastic, synthetic material, or laminated material;
(b) at least one of a magnetic strip, a 2-D bar code, or a QR code secured to the substrate;
(c) the magnetic strip, 2-D bar code, or QR Code containing electronically readable information about an amount of money;
wherein, when the magnetic strip, 2-D bar code, or QR code is electronically read, the amount of money is credited in a sale transaction.

2. The device of claim 1 wherein the magnetic strip, 2-D bar code, or QR code is removably secured to the substrate.

3. The device of claim 1 wherein the 2-D bar code or QR bar code is printed on the substrate.

4. The device of claim 1 wherein the 2-D bar code or QR bar code is printed on a removable portion of the substrate.

5. The device of claim 1 wherein the substrate is at least one of a greeting card, birthday card, graduation card, special occasion card, or a name card.

6. The device of claim 1 wherein the substrate is printed advertising.

7. The device of claim 1 wherein the substrate is at least one of a greeting card, a business card, or a name card.

8. The device of claim 1 wherein the magnetic strip, 2-D bar code, or QR Code containing electronically readable information identifying a user who receives the substrate.

9. The device of claim 1 wherein the magnetic strip, 2-D bar code, or QR code is not detectable when mailed or shipped to a recipient.

10. A method of using a magnetic strip, 2-D bar code, or QR bar code comprising:
(a) acquiring a substrate having at least one of a magnetic strip, 2-D bar code, or QR bar code secured thereto, the magnetic strip, 2-D bar code, or QR bar code containing electronically readable information about an amount of money;
(b) passing the substrate through a reader in connection with a sale transaction so as to credit an amount of money in connection with a sale transaction.

11. The method of claim 10 wherein the substrate is at least one of a greeting card, a business card, or a name card.

12. The method of claim 10 wherein the magnetic strip, 2-D bar code, or QR bar code is removably secured to the substrate.

13. The method of claim 10 wherein the magnetic strip, 2-D bar code or QR bar code is removably secured to the substrate by adhesive.

14. The method of claim 10 wherein the substrate has a perforated portion that may be removed from the substrate, the 2-D bar code, QR bar code, or magnetic strip being secured to the removable perforated portion of the substrate.

15. The method of claim 14 wherein the perforated portion of the substrate is removed from the substrate before being passed through the reader.

16. The method of claim 10 wherein the substrate is printed advertising, and the 2-D bar code, QR bar code, or magnetic strip is removed before it is passed through a reader.

17. The device of claim 10 wherein the substrate is at least one of a greeting card, a business card, or a name card.
